(19) United States
(12) Patent Application Publication
(10) Pub. No.: US 2004/0257437 A1
(43) Pub. Date: Dec. 23, 2004

(54) Sure shot mount

(76) Inventor: Todd Lesseu, Graysville, TN (US)

Correspondence Address: RALPH E. SAUCIER SR., 1927 PIERCE WAY, BUFORD, GA, 30519, US

(21) Appl. No.: 10/465,299

(22) Filed: Jun. 20, 2003

(51) Int. Cl. H04N 7/18

(52) U.S. Cl. 348/61

(57) ABSTRACT

The uniqueness of the Sure Shot Mount invention is the simplicity of usage and the conveniece for the shooter to be able to use it in the field. There are no other products on the market nor any that have been patented that allows a shooter to video tape what he is shooting with the camera being mounted on the receiver where the scope normally goes.

The unit can be put together in the field with just a few screws. It does not have to have any special case to carry it, although one could be provided. When the Sure Shot is done being used it is easily demounted from the receiver with the removal of a few screws. The scope can then easily be remounted to the receiver with the same screws that held the Sure Shot Mount on.

Purpose—is to be able to mount a video camera on the gun and be able to take a video of what the hunter is actually aiming. This is done with the mount sitting on the rifle receiver where the scope normally is mounted. With the mount in this position the person is able to aim the camera in the same direction as the rifle barrel. This in turn allows the person to view whatever takes place in front and be able to scan before firing. When he does fire on the prey, he is then able to keep the video as a trophy. The video also can be used as a training tool for assisting individuals on aiming and firing of the weapon.

Function—The Sure Shot is done by first removing the top mounting rings. Keep the screws for the top rings and use them for remounting the Sure Shot. Once the mounting of the Sure Shot is complete align the scope to its level position and tighten all four screws.

The camera is then mounted on the camera mount plate by dropping the anchor screw on the bottom of the camera into the slot of the camera mount plate. Using a thumbscrew; under the camera mount plate, you tighten the camera onto the plate ensuring that it is tight. The camera is now ready to be used by the individual.

### Operating the Sure Shot Mount

a.—Attaching the Sure Shot Mount—The Sure Shot first has to be assembled. The first step in doing this is to place the bed of the Sure Shot in the two upright cradles. In (FIG. 1; Item 100) is the base and in (FIG. 1; Item 101) are the two uprights that support the base and what mounts to the riflescope. When the base has been set into the channels on the uprights (FIG. 2; Item 103) you then tighten down on the setscrews on the side of the uprights (FIG. 1; Item 104). The base has the extensions on both ends to allow locating the Sure Shot Mount in relation to the scope and for the eye of the hunter. It is not necessary to over tighten the setscrews. The Sure Shot Mount is now ready to mount to the rifle scope.

To mount the Sure Shot Mount on top of the scope you remove the (4) screws that clamp the scope down. The Sure Shot Mount is then placed on top (FIG. 3 and FIG. 4) of the riflescope brackets. The same screws that held the scope on are now placed in the upright holes (FIG. 4; Item 105) in all (4) locations or in each hole, which held the scope on. Tighten these (4) screws down with reasonable slight hand torque.

B—Using the Sure Shot Mount The camera can now be mounted to the top of the Sure Shot Mount. To do this you use the thumbscrew (FIG. 5; Item 106) that comes with the camera; if you don't have one you need to pick up a thumbscrew that will fit your particular camera. Mount the camera (FIG. 5; Item 107) on top of the Sure Shot Mount. The thumbscrew can now be tightened down to the Sure Shot Mount. As you tighten the thumbscrew hold the camera straight so it will not turn direction during tightening. The Camera and the Sure Shot Mount are now ready to be used as one unit.

### DESCRIPTION OF DRAWINGS

FIG. 1 Shows the components for the Sure Shot Mount before they are assembled and the relationship they have to each other.

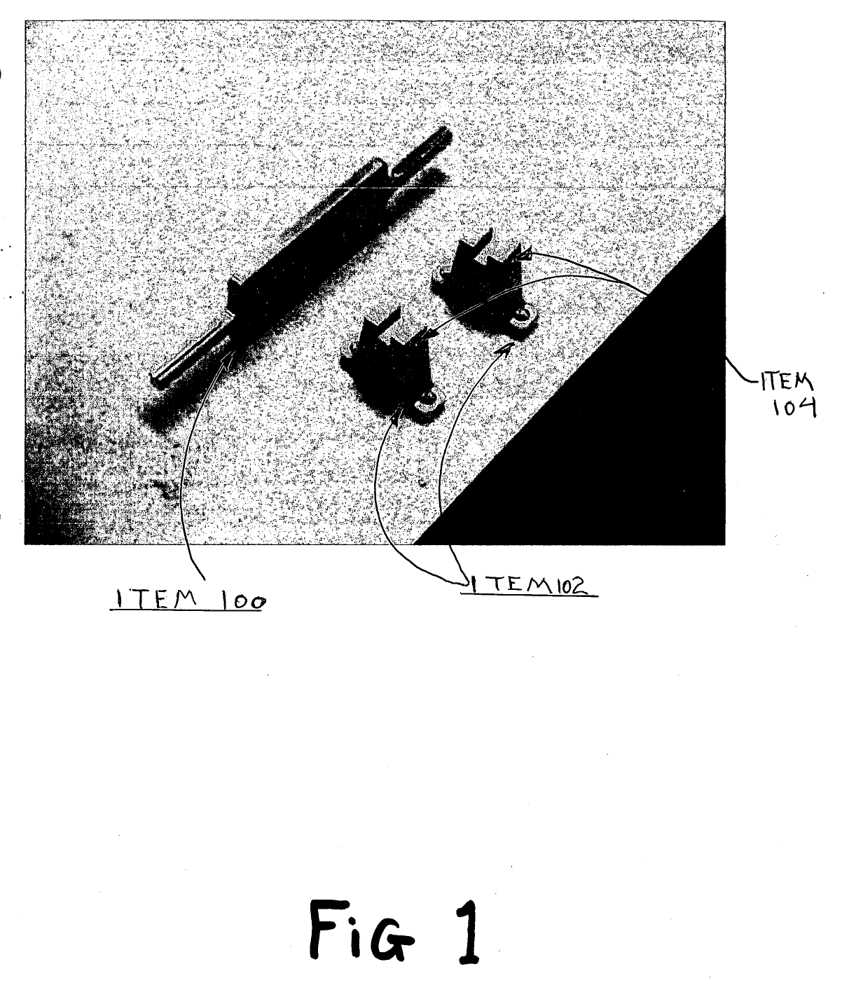

FIG. 2 Shows the Sure Shot Mount in the assembled position with the base facing up to allow for the mounting of the camera.

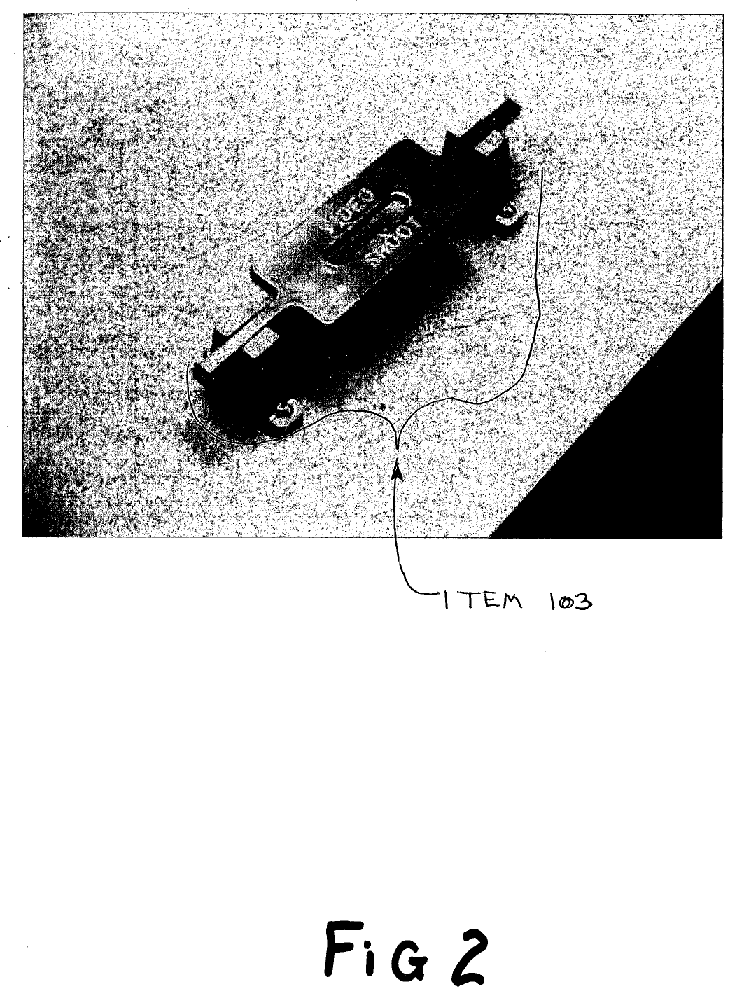

FIG. 3 Shows the side view of what the Sure Shot Mount should look like after it is mounted to the top of the riflescope.

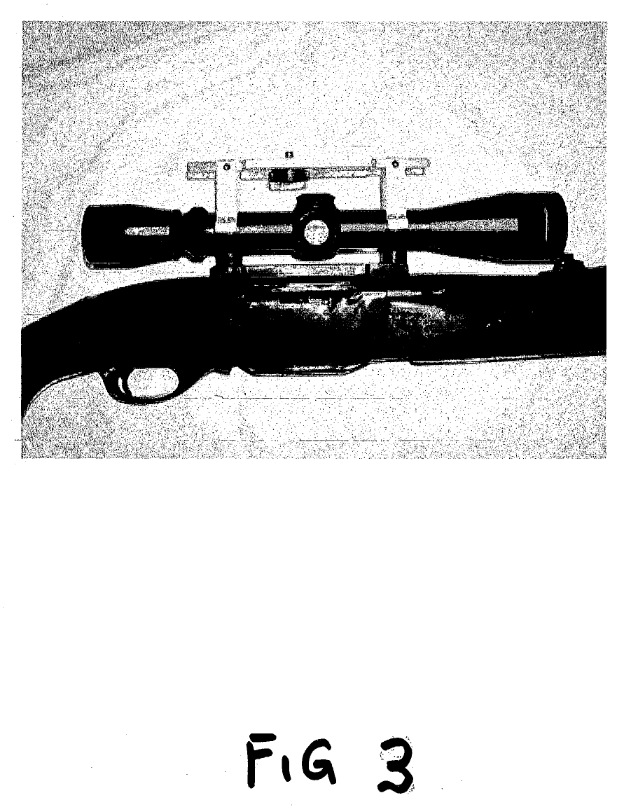

FIG. 4. Shows the top view of the Sure Shot Mount mounted on top of the scope with the screws in place.

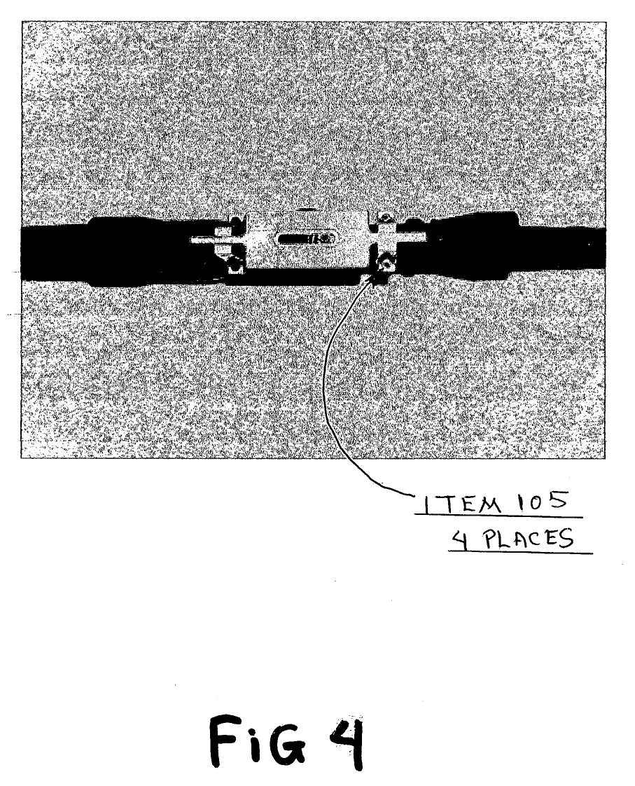

FIG. 5 Shows the camera mounted on the Sure Shot Mount ready to be operated.

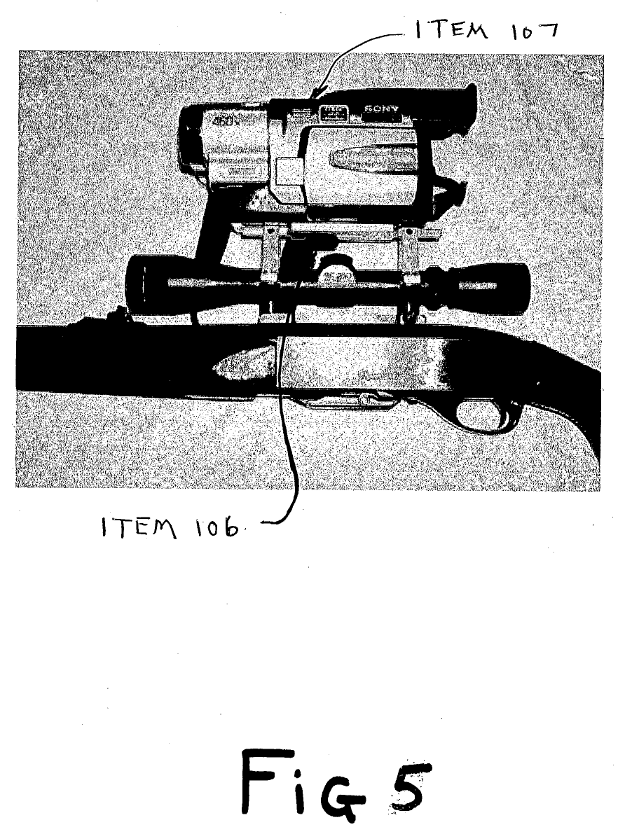

I claim:

1. The Sure Shot Mount is the only mount manufactured to mount on a rifle receiver allowing the shooter to video tape what he is aiming at and to shoot at the target at the same time.

2. The Sure Shot Mount is the only video mount for a rifle receiver.

3. The Sure Shot Mount is the only video mount that can be mounted with the ease of taking the scope off and using the same mount to put the Sure Shot Mount on.
